(19) United States
(12) Patent Application Publication
(10) Pub. No.: US 2008/0078656 A1
(43) Pub. Date: Apr. 3, 2008

(54) CURVED BELT CONVEYOR WITH AUTOTRACKING DEVICE

(75) Inventors: David E. Rhodea, Allendale, MI (US); Richard E. Hoisington, Farmington, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DEMATIC CORPORATION, Grand Rapids, MI (US)

(21) Appl. No.: 11/865,385

(22) Filed: Oct. 1, 2007

Related U.S. Application Data
(60) Provisional application No. 60/849,164, filed on Oct. 3, 2006.

(51) Int. Cl. B65G 21/16; B65G 43/00

(52) U.S. Cl. 198/831; 198/810.03

(57) ABSTRACT

A belt conveyor includes opposite sidewalls and at least two rollers positioned between the sidewalls with a continuous belt reeved around the rollers. A tracking device is mounted at one of the sidewalls and adjustably supports an end of an adjustable roller of the conveyor. The tracking device adjusts an angle of the adjustable roller relative to the sidewalls to track the belt with the rollers. The tracking device may include a biasing element to urge the end of the adjustable roller to maintain tracking of the belt around the rollers.

### CROSS REFERENCE TO RELATED APPLICATION

The present application claims benefit of U.S. provisional application Ser. No. 60/849,164, filed Oct. 2, 2006, which is hereby incorporated herein by reference in its entirety.

### FIELD OF THE INVENTION

The present invention relates generally to conveyors and, more particularly, to a belted conveyor which conveys articles around a curve.

### BACKGROUND OF THE INVENTION

It is known to provide zones of rollers in a curved roller conveyor, where each zone includes a motorized roller and a plurality of idler or freely rotating rollers. The motorized roller may be operable to drive the idler rollers via a plurality of O-rings connecting each roller to an adjacent roller or rollers in the zone. Each zone may be independently operable to accumulate articles on a particular zone or zones or to generally continuously convey articles along the zones of the roller conveyor. However, such roller conveyors are not suitable for applications where belt conveyors are desired, such as for conveying small articles which may fall between the rollers, or for applications where a belt conveyor may be required or desired for other reasons. Also, due to the low friction between the rollers and the articles being conveyed thereon, such roller conveyors are typically not suitable for providing accumulation of articles along an inclined or declined section of the roller conveyor. The low friction between the rollers and the articles also may limit the speed at which the articles may be conveyed around a curve, because the articles tend to slide outwardly as they move along the curve.

Curved belt conveyors have been proposed which provide a belt conveyor through a curved section. However, such curved conveyors typically require tracking or guiding devices to maintain or track the belt in the proper position around the belt rollers. The tracking devices or guiding devices are positioned along the curve and either radially inwardly of the belt or radially outwardly of the curved belt, and are attached directly to the belt, such as along the inner or outer edge of the belt. The tracking devices function to guide and hold the belt in the desired position around the belt rollers. This typically requires that the side channels of the conveyor sidewalls have a greater width to accommodate the additional tracking, guiding and/or take up devices, which results in the conveyor having a greater width through the curved sections. Additionally, the belt or one of the belt rollers is driven by a motor typically positioned beneath the belt and belt rollers or along the curve and radially inward of the belt or radially outward of the belt. Such roller conveyors are typically not suitable for providing accumulation of articles along the curve.

Therefore, there is a need in the art for a curved belt conveyor that overcomes the shortcomings of the prior art.

### SUMMARY OF THE INVENTION

The present invention provides a curved belt conveyor which is suitable for continuously conveying articles along curved zones or segments and/or accumulating articles on the individual curved zones or segments. The curved belt conveyor includes one or more curved segments or zones, each of which includes a continuous belt routed around a plurality of rollers and optionally supported between a pair of spaced apart rollers by one or more other rollers and/or a slide plate or the like. Each of the curved zones may include a driven roller or motorized roller and one or more idler rollers and may be independently operable to move articles along the curved belt conveyor or to accumulate articles on one or more of the curved zones of the curved belt conveyor. A mounting end of one of the end rollers of the conveyor is adjustably mounted at the sidewall so that the angle of the end roller is adjustable to adjust the tracking of the belt around the rollers.

According to an aspect of the present invention, a belt conveyor comprises at least one zone or section having a plurality of rollers and a continuous belt routed or reeved around at least two of the rollers. The rollers are positioned along and between opposite sidewalls of the conveyor, such as curved opposite sidewalls defining a curved conveyor zone or section. The conveyor includes a tracking device or roller mounting device or roller adjustment device that functions to adjust a position of an end of one of the at least two rollers along the respective sidewall to adjust a tension in the belt. The belt may be tracked with the rollers by surface contact with at least one of the rollers and by adjustment of the location of the end of the adjustable roller by the tracking device or roller mounting or adjustment device.

According to another aspect of the present invention, a belt conveyor comprises at least two zones. Each of the zones has a plurality of rollers and a continuous belt routed or reeved around the rollers. The rollers are positioned along and between opposite sidewalls of the conveyor, such as curved opposite sidewalls. The belts are tracked with the rollers. Each of the zones of the conveyor includes a tracking device or roller mounting device or roller adjustment device that functions to adjust a position of an end of one of the at least two rollers along the respective sidewall to adjust a tension in the belt. The belts of the zones may be tracked with the rollers by surface contact with at least one of the rollers and by adjustment of the location of the end of the roller by the respective tracking device or roller mounting or adjustment device.

Optionally, and desirably, each of the zones of the belt conveyor may define a curve of between approximately 10 degrees and approximately 30 degrees. Optionally, each of the zones may define a curve of approximately 15 degrees or approximately 22.5 degrees. The zones may combine to establish a curved belt conveyor that may curve between 10 degrees and 360 degrees or more depending on the particular application of the belt conveyor.

Each curved zone may be independently operable to allow for accumulation of articles at one or more of the curved zones along the curved belt conveyor. Each curved zone may further include an article sensor which is operable to detect articles on the belt of the respective zone, whereby each curved zone may be operable in response to the article sensor and the particular application of the curved belt conveyor. Optionally, the curved belt conveyor may be implemented at an incline or a decline, and may be operable to accumulate articles on the incline or decline.

According to another aspect of the present invention, a method of conveying articles includes providing a belt conveyor comprising opposite sidewalls, at least two rollers positioned along and between the opposite sidewalls and a continuous belt reeved around the rollers. The rollers comprise an adjustable roller and an end roller. An end of the adjustable roller is automatically adjusted to adjust an angle of the adjustable roller relative to the sidewalls to track the belt with the rollers. The automatic adjustment of the end of the adjustable roller may be in response to a change in tension in the belt as the belt moves along the rollers, such as toward an inner curved sidewall or toward an outer curved sidewall of a curved belt conveyor.

Therefore, the present invention provides a belt conveyor and method that automatically tracks the belt around the rollers via a belt tensioning device or roller adjustment device or roller mounting device that adjusts the angle of an end roller via adjustment of an end of the end roller along the conveyor sidewall. The belt conveyor may accumulate articles along one or more curved zones or sections of the belt conveyor. The zones may be individually operable to convey or accumulate articles therealong or thereon, such as via a motorized roller or other rotatably driven roller that drives the belt around the rollers of the respective zone. The roller mounting device or tracking device or roller adjustment device or tracking means may maintain or track the belt in its proper position or orientation around the rollers via automatically adjusting the angle of an end tapered roller to adjust the belt angle around the end rollers and thus to adjust the position of the belt along the roller, such that external tracking devices attached to the belt itself and/or wider conveyor portions of conventional curved belt conveyors are not required in connection with the curved belt conveyor of the present invention. Because the separate and external tracking devices attached to the belt are not required to maintain the belt in place on the rollers, the curved belt conveyor of the present invention may be designed within the confines of standard width conveyors and conveyor sidewalls.

These and other objects, advantages, purposes and features of the present invention will become apparent upon review of the following specification in conjunction with the drawings.

### BRIEF DESCRIPTION OF THE DRAWINGS

FIG. 1 is an upper perspective view of a curved belt conveyor in accordance with the present invention, with the belt removed from an upstream zone to show additional details;

FIG. 2 is an upper plan view of the curved belt conveyor of FIG. 1;

FIG. 3 is an end elevation of the curved belt conveyor of FIG. 2;

FIG. 4 is a sectional view of the curved belt conveyor taken along the line IV-IV in FIG. 2;

FIG. 4A is a sectional view similar to FIG. 4, showing a roller with an elongated shaft extending through the roller for mounting the roller to the sidewalls;

FIG. 5 is an upper perspective view of the curved belt conveyor of the present invention as viewed from the inside of the curve;

FIG. 6 is an upper perspective view similar to FIG. 5, with the inner sidewall removed to show additional roller details;

FIG. 7 is an upper perspective view similar to FIG. 5, with the belt removed from the rollers;

FIG. 8 is a side elevation of a portion of the inner sidewall of the curved belt conveyor, showing a slotted opening for receiving the shaft or shaft portion of one of the rollers therethrough;

FIG. 9 is a side elevation of a portion of the curved belt conveyor, showing a roller adjustment mechanism in accordance with the present invention;

FIG. 10 is a side elevation of a portion of a curved belt conveyor of the present invention;

FIG. 11 is a sectional view of the curved belt conveyor taken along the line XI-XI in FIG. 10;

FIG. 12 is a perspective view of another roller adjustment mechanism or tracking device of the present invention;

FIG. 13 is another perspective view of the roller adjustment mechanism or tracking device of FIG. 12;

FIG. 14 is a top plan view of the roller adjustment mechanism or tracking device of FIGS. 12 and 13;

FIG. 15 is a side elevation of the roller adjustment mechanism or tracking device of FIGS. 12-14; and

FIG. 16 is a perspective view of another roller adjustment mechanism or tracking device of the present invention.

### DESCRIPTION OF THE PREFERRED EMBODIMENTS

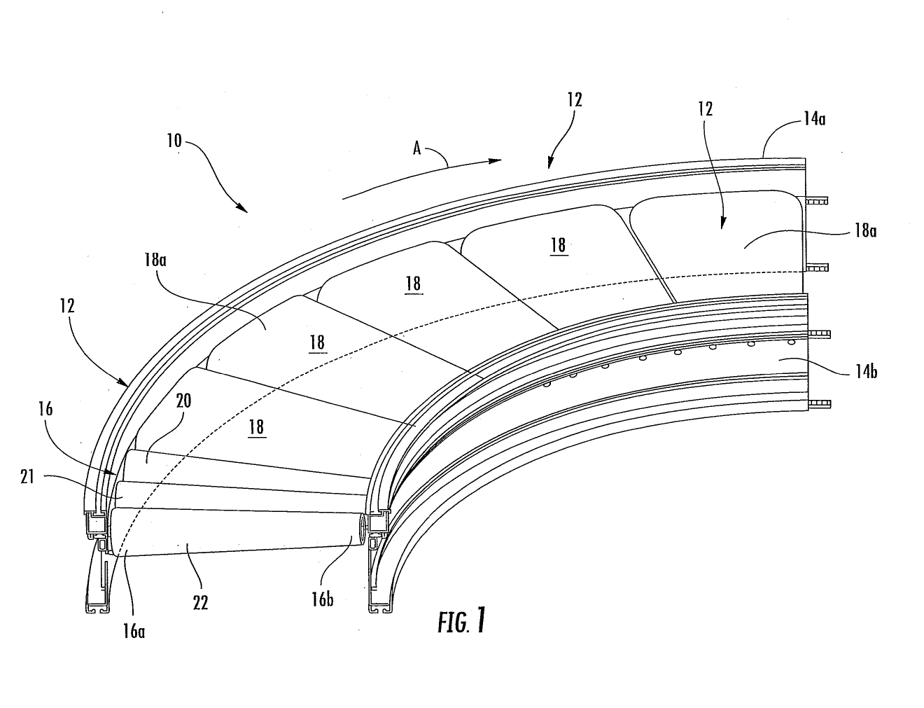

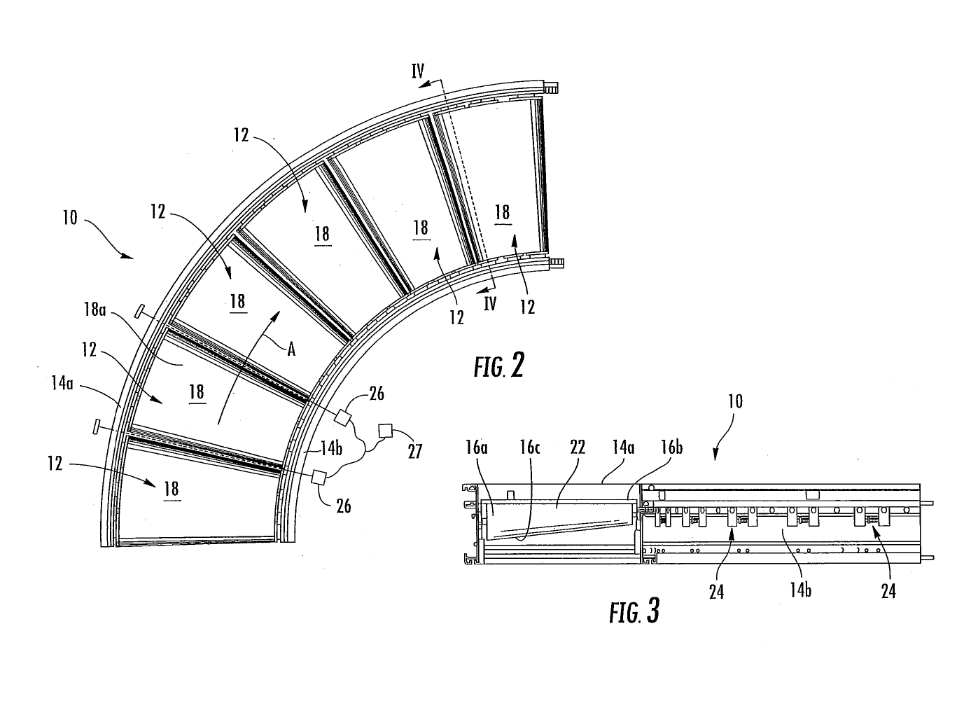

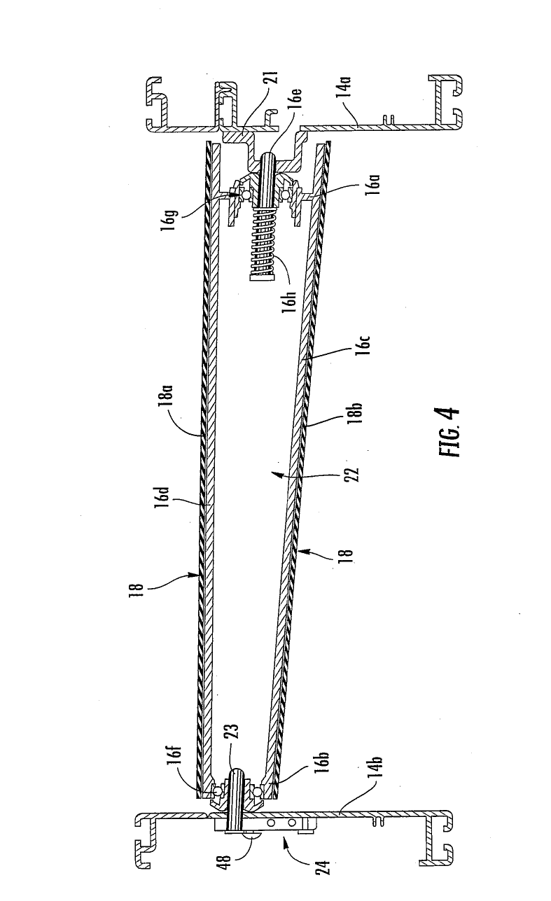

Referring now specifically to the drawings and the illustrative embodiments depicted therein, a curved belt conveyor 10 includes a plurality of curved portions, sections, zones or segments 12 positioned along and between an outer curved sidewall or side frame 14a and an inner curved sidewall or side frame 14b, and is operable to convey articles in a direction of conveyance A (FIGS. 1 and 2). Each curved segment or zone 12 includes at least two rollers 16 and a continuous belt 18 routed or reeved around the rollers 16. The rollers 16 are angularly oriented and positioned along each zone and may include a driven roller 20, such as at a downstream or discharge end of each zone, and at least one idler roller 22, such as at an upstream end of each segment or zone. Curved belt conveyor 10 includes a means for tracking the belt or automatic tracking device or roller adjustment device 24 (FIG. 3) which is operable to adjust an angle of an end roller, such as upstream end roller or idler roller 22, to track belt 18 around rollers 16, as discussed below. Curved belt conveyor 10 may utilize aspects of the curved belt conveyors described in U.S. Pat. Nos. 6,971,510 and 7,150,352, which are hereby incorporated herein by reference in their entireties.

A typical belt curve consists of a curved frame having curved opposite sidewalls or side channels that hold tapered rollers that support a belt. As the belt is driven around the rollers, the belt tends to move along the tapered rollers and toward the center of the curve or toward the inner sidewall of the curved conveyor. Traditional belt curves use a mechanical system to hold the belt in place to keep the belt from moving towards the center of the curve. Such mechanical systems typically engage an edge of the belt to retain the belt at the desired or appropriate position around the rollers.

The curved belt conveyor of the present invention includes a curved frame or curved sidewalls and may be divided into 15 degree conically belted zones (or other curvatures, such as discussed below) consisting of two tapered idler rollers and a tapered drive roller. Unlike conventional belt curves, the curved belt conveyor of the present invention does not use a mechanical system that engages the edge of the belt to hold the belt in the correct or tracked position/orientation. Instead, the curved belt conveyor and tracking device or roller adjustment device of the present invention controls and tracks the belt by changing the angle formed by the two end rollers. For example, the upstream end tapered idler roller may be adjustable by the tracking device and allowed to travel or pivot away from the tapered drive roller (at the downstream end of the zone), thus decreasing the angle of contact of the rollers. This may be accomplished by changing the axle location of the idler roller at the inner side channel of the conveyor. When the contact angle is decreased, the conical belt will move away from the center of the curve and toward the outer sidewall of the conveyor. Thus, by controlling the angle of the rollers (and desirably by controlling the angle or orientation of the upstream idler roller relative to the sidewalls), the position of the belt around the rollers can be controlled.

As the belt moves away from the center of the curve (such as in response to the angle of the upstream roller being adjusted), the belt begins to “climb” the tapered rollers toward the outer sidewall. As the belt climbs the tapered rollers (i.e. moves toward the larger diameter ends of the rollers), the tension on the belt increases (due to the larger curved distance or arc or dimension between the outer ends of the end rollers compared to the curved distance or arc or dimension between the inner ends of the end rollers). The tension created in the belt during such movement of the belt along the rollers can be used to control the angle of the tapered rollers. As the tension increases, it creates a reaction force that attempts to push the two outside rollers towards each other. Thus, the tracking device of the present invention includes a biasing element or spring placed at the inner side channel or sidewall and counters the force generated by the tension in the belt. As the belt moves outward toward the outer sidewall, the tension in the belt may increase to the point that the generated force of the belt is greater than the compression force of the spring. When the tension in the belt meets or exceeds the spring force, the spring begins to compress allowing the tapered end idler roller's position at the inner side channel to change. As the tapered end idler roller moves or pivots (such as by moving the inner end of the upstream end roller toward the downstream end of the conveyor), the angle between the two end rollers increases and the belt moves back towards the center of the curve. As the belt moves toward the center of the curve, the tension in the belt decreases, and the spring may then urge the inner end of the end idler roller in the opposite direction or toward the upstream end of the conveyor, whereby the decrease in angle of the end rollers results in the belt again moving outward along the rollers and toward the outer sidewall of the conveyor. The biasing element or spring of the tracking device of the present invention thus acts to balance the tension on the belt to control the position of the belt around the rollers.

Each belted segment or zone 12 of curved belt conveyor 10 may be independently operable to accumulate articles on the curved segment or to move articles in the direction A onto a next, adjacent curved segment or to a discharge area or onto another conveyor, such as another belt conveyor, or a roller conveyor, slider bed, or the like, or any other means for receiving articles from a discharge end of the last zone or segment of the curved belt conveyor 10. Curved belt conveyor 10 may, for example, convey articles onto an adjacent straight belted conveyor, such as the types disclosed in U.S. Pat. Nos. 6,811,018 and 7,093,709, and U.S. patent application Ser. No. 11/504,509, filed Aug. 15, 2006 by Cotter et al. for BELT CONVEYOR (Attorney Docket DEM04 P-100C), which are hereby incorporated herein by reference in their entireties, or onto another curved belted conveyor, such as of the types disclosed in U.S. Pat. Nos. 6,971,510 and 7,150,352, which are hereby incorporated herein by reference in their entireties, or any other known or conventional straight or curved conveyor or conveying surface or the like.

Optionally, the belt may have a low modulus characteristic and may have at least approximately a 0.75 percent initial stretch in its lengthwise direction when the belt is reeved or positioned around the rollers, such as a belt of the types described in U.S. Pat. Nos. 6,811,018; 6,971,510; 7,093,709 and 7,150,352, and U.S. patent application Ser. No. 11/504,509, filed Aug. 15, 2006 by Cotter et al. for BELT CONVEYOR (Attorney Docket DEM04 P-100C), which are hereby incorporated herein by reference in their entireties. The low modulus characteristic of the belt may provide approximately a 2 percent to 4 percent or more stretch capability or characteristic to the belt. This may provide a substantially greater amount of stretch over conventional conveyor belts, which may typically only provide approximately a 1 percent stretch capability or characteristic, and which are typically reeved around the rollers with only about a 0.25 percent initial stretch. The low modulus belt may be made from urethane extrusions or urethane with polyester or nylon tension members encapsulated, and may be similar to the type of belts commercially available from Nitta Corporation for use in graphic arts and letter mail sorting. The low modulus characteristic of the belt may allow the belt to remain in its proper position or orientation or to remain tracked around the rollers, such that belt engaging tracking devices and wider conveyor portions of conventional curved belt conveyors are not required in the curved belt conveyor of the present invention. Because separate tracking devices are not required at the belt to maintain the low modulus belt in place on the rollers, the curved belt conveyor of the present invention may be designed within the confines of standard width conveyors.

In the illustrated embodiment, each zone 12 includes two end rollers, with one of the end rollers being adjustable via the roller adjustment device 24 and the other end roller being non-adjustably mounted to and between the opposite sidewalls 14a, 14b. In the illustrated embodiment, the downstream or lead roller 20 is non-adjustable and the upstream or trailing end roller 22 is adjustable. As shown in FIG. 1, the downstream or lead roller (the roller at the downstream end of the conveyor or zone) may comprise a tapered driven roller 20 and the upstream or other end roller 22 (the roller at the upstream end of the conveyor or zone and opposite from the lead roller) and any other rollers 21 between the end rollers may comprise one or more tapered idler rollers, each of which has an outer end 16a which is wider or of a greater diameter than an inner end 16b. Driven roller 20 is positioned as the lead roller of the zone, and may thus be positioned at a downstream end of each curved segment or zone 12, and thus may be operable to pull the belt 18 (and the articles supported thereon) along the respective segment or zone 12.

Driven roller 20 may comprise a self driven or motorized roller with an internal motor which is operable to rotate a roller portion relative to a shaft portion of the roller, such as a motorized roller of the types commercially available from various sources. For example, driven roller 20 may comprise a DC motorized roller, such as a 12 volt DC motorized roller or the like, such as a roller of the type disclosed in U.S. Pat. No. 6,244,427, the disclosure of which is hereby incorporated herein by reference in its entirety. Optionally, the motorized roller may comprise a 24 volt DC motorized roller or a 42 volt DC motorized roller or a 48 volt DC motorized roller or the like. It is further envisioned that the motorized roller may comprise other DC powered motorized rollers, or may comprise an AC powered motorized roller, such as described in U.S. Pat. No. 5,442,248, the disclosure of which is hereby incorporated herein by reference in its entirety, without affecting the scope of the present invention. The motor of the motorized roller may drive the roller directly, such as disclosed in U.S. Pat. No. 6,244,427, or may drive the roller via a gear train or the like, such as disclosed in U.S. Pat. No. 5,442,248, the disclosures of which are hereby incorporated herein by reference in their entireties. Because the rollers 16 of curved belt conveyor 10 may include such a driven roller 20, curved belt conveyor 10 also may not include an external drive motor positioned beneath the belt and rollers or positioned along the curve and radially inwardly or outwardly of the conveyor sidewalls. Optionally, however, the driven roller may comprise any other suitable rotatably driven roller that is rotatably driven (either via an internal motor or an external drive motor and associated drive belt or band or shaft or the like) to rotate a roller portion of the roller about the axle or shaft of the roller to drive the belt along the conveyor.

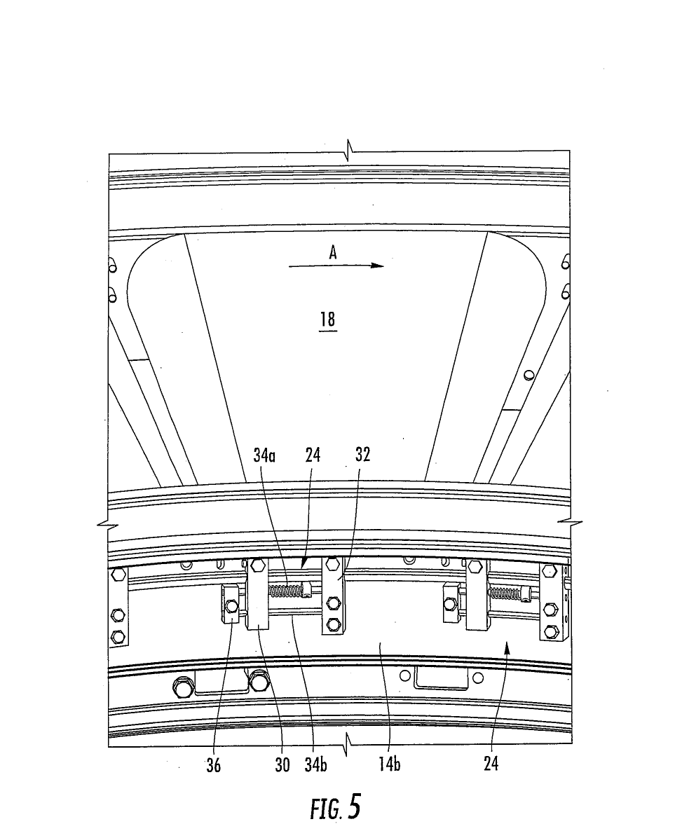

Driven roller 20 thus is operable to rotate the rotatable roller portion of the roller to drive continuous conveyor belt 18, which moves along the idler rollers 22, 21 which may generally freely rotate about their axle or shaft portions to guide and support the belt 18 around the zone or segment 12. The idler rollers 22, 21 may be any type of rollers, such as conventional, freely rotating rollers, such as the types also commercially available from various sources. Although shown in FIGS. 1-6 as having multiple idler rollers along each of the zones 12, one or more zones of the curved belt conveyor of the present invention may include a support plate or slider bed or support roller or rollers between the driven roller 20 and an opposite end idler roller 22 to support the belt 18 between the ends of the zone 12, without affecting the scope of the present invention. For example, a curved slide plate may be positioned between the tapered driven roller and the tapered idler roller to support the upper run of the belt between the pair of rollers or end rollers of the zone.

Belt 18 may be routed around the rollers 16 such that the upper run 18a of belt 18 is routed over and along the upper surface 16d of the rollers and the lower run 18b of belt 18 is routed under the rollers and along the lower surface 16c, as can be seen with reference to FIG. 4. As can also be seen in FIG. 4, the idler roller 22 may be mounted to the outer sidewall 14a of curved belt conveyor 10 via an inwardly positioned mounting bracket or support 21 mounted to or affixed to the inner surface of outer sidewall 14a (although an idler roller 22 is shown in FIG. 4, the driven rollers may be mounted to conveyor 10 in a similar manner). Mounting bracket 21 may provide a mounting aperture for receiving an end of a shaft portion 16e (extending from a bearing element or assembly 16g) of outer end 16a of the roller to non-rotatably support the outer end of shaft portion 16e of the roller. Shaft portion 16e may be biased outwardly via a biasing element or spring 16h. The other end or inner end 16b of the roller 22 may be supported by a similar stub axle or by a reversed stub axle 23 that is inserted through the sidewall 14b and into a bearing element or assembly 16f at the inner end 16b of the roller 22. As shown in FIG. 4, the reverse stub axle 23 may be inserted through adjustment device or tracking device 24 to adjustably support the inner end 16b of roller 22 at the inner sidewall 14b, as discussed below.

Optionally, and as shown in FIG. 4A, an elongated shaft portion 16e′ of an idler roller 22′ may be spring loaded or biased via a biasing member or spring 16h′ to allow shaft portion 16e′ to be moved inward at one end 16a′ of roller 22′ to facilitate alignment of the roller with the mounting bracket 21, whereby the shaft portion 16e′ may be released to extend into the corresponding opening in the mounting bracket 21′ in response to biasing member 16h′. The opposite end of shaft portion 16e′ (such as at inner end 16b′ of roller 22′) may insert into a corresponding aperture in inner sidewall 14b, and may insert into an aperture at adjustment device 24 so as to be adjustably supported at the sidewall 14b. Other suitable means for mounting and supporting the rollers at the conveyor sidewalls may be implemented while remaining within the spirit and scope of the present invention.

Mounting bracket 21 thus provides a shaft support for the end of the roller shaft such that the end of the shaft or axle or axle portion is positioned at the inner side of outer sidewall 14a and does not extend through outer sidewall 14a, as the opposite end of the shaft or axle or axle portion may through inner sidewall 14b, and as may typically occur with conventional rollers and sidewalls. Because the roller shafts do not extend through the outer sidewall 14a of conveyor 10, the shafts do not interfere with the area outside of outer sidewall 14a. The mounting bracket 21 thus may facilitate positioning a control box or other equipment or component (not shown in FIG. 4) at the outer area of outer sidewall 14a and generally or substantially within the C-channel defined by outer sidewall 14a. As can be seen in FIG. 4, the roller portion of roller 16 may extend outwardly beyond the bearing assembly 16g of the roller 16 to extend substantially toward outer sidewall 14a and around bracket 21 to provide a conveying region which may substantially span the area between sidewalls 14a, 14b. The other or inner end of the rollers are mounted to the inner sidewall 14b, with one of the rollers having its inner end mounted at or to the tracking device 24.

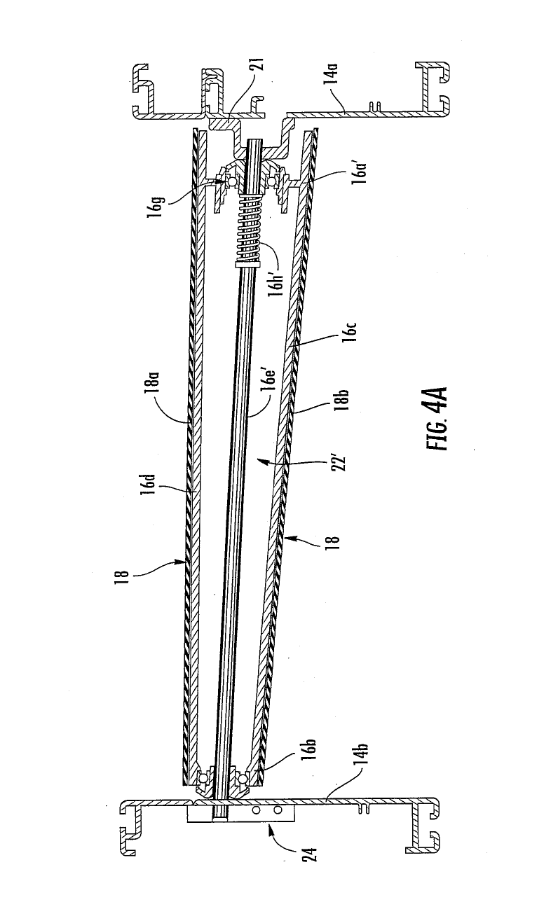

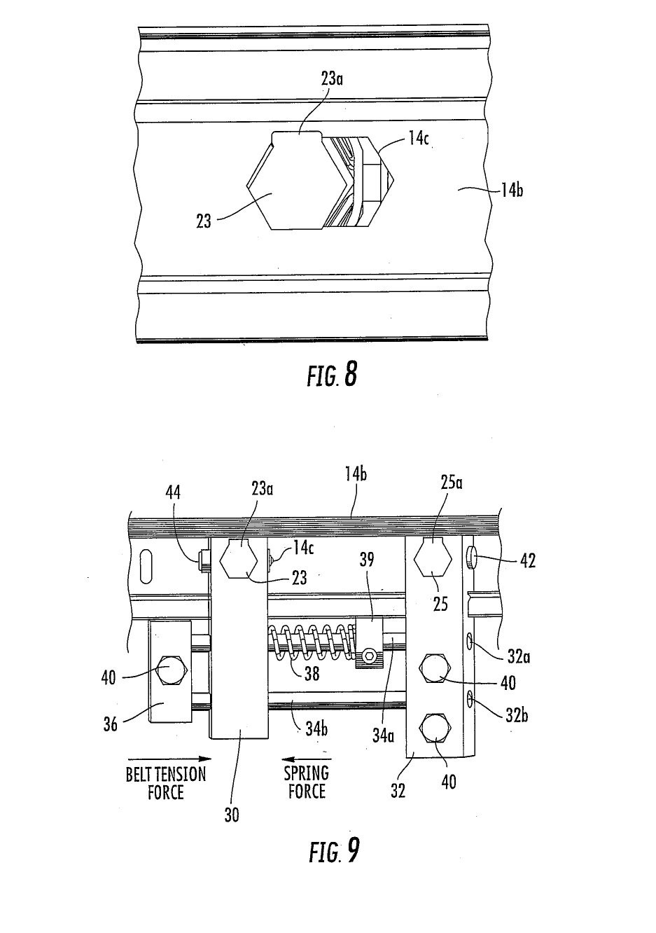

As best shown in FIGS. 5, 7 and 9, roller adjustment device 24 comprises a movable roller mounting element 30 that movably or adjustably mounts the end of the roller 22 at the inner sidewall 14b. Movable roller mounting element 30 is movable or adjustable relative to a fixed or substantially fixed mounting element 32 that is secured to or attached to the inner sidewall 14b. In the illustrated embodiment of FIGS. 1-9, movable roller mounting element 30 is movable or adjustable along a support rod or element, such as a pair of support rods or posts 34a, 34b that each have one end supported or secured at mounting element 32 and the opposite ends supported or secured at a fixed support element or second mounting element 36, with the support rod or rods extending generally along sidewall 14b and between the mounting element 32 and support element 36. The mounting elements 32, 36 of adjustment device 24 are mounted at inner sidewall 14b via fasteners 40, such as bolts or the like, through mounting element 32 and mounting element 36 and into or through inner sidewall 14b to secure the mounting elements 32, 36 to the inner sidewall 14b. Thus, one end of each of the posts 34a, 34b may be supported at mounting element 32 (such as by being at least partially received into or through apertures or passageways 32a, 32b (FIG. 9) at least partially through mounting element 32), while the other ends of the posts may be supported at mounting element 36 (such as by being at least partially received into or through apertures or passageways (not shown) at least partially through mounting element 36), with the movable roller mounting element 30 positioned between the mounting element 32 and mounting element 36 and movable along posts 34a, 34b.

Movable roller mounting element 30 is thus movable along the posts 34a, 34b, such as via sliding movement along the posts, which extend through apertures or passageways through movable roller mounting element 30. As best shown in FIGS. 5, 7 and 9, movable roller mounting element 30 is biased or urged along the posts 34a, 34b and sidewall 14b and away from the driven roller at the opposite or forward or lead or downstream end of the conveyor or zone. In the illustrated embodiment, movable roller mounting element 30 is biased toward the upstream end of the conveyor or zone (in the opposite direction as the direction of conveyance A of the conveyor or zone) via a biasing element or spring 38 at or along one of the posts 34a that biases or urges the movable roller mounting element 30 away from mounting element 32 and toward mounting element 36. Thus, biasing element 38 urges movable roller mounting element 30 (and the end of the roller that is supported by movable roller mounting element 30) toward the upstream end of the conveyor or zone to maintain the belt at the desired tension to thus track the belt around the rollers. Biasing element 38 may be located along post or rod 34a, with one end engaging a stop collar or element 39 and the other end engaging the movable roller mounting element 30 and urging or biasing the movable roller mounting element along the post and away from the stop collar 39 and mounting element 32. Biasing element 38 may be selected to provide a desired or appropriate biasing force or spring force to track the belt along the rollers. For example, the biasing element or coil spring may have a spring force or load of about 11 pounds (48.5 Newtons) or other suitable biasing force, and may be adjusted or compressed to provide the desired or appropriate or suitable spring force at the movable roller mounting element, depending on the tension in the belt during operation of the curved belt conveyor.

As can be seen in FIGS. 8 and 9, the axle portion or stub axle 23 of upstream end roller 22 is non-rotatably received through an aperture in movable support element 30. For example, a hexagonal-shaped stub axle may be received through a correspondingly formed hexagonal-shaped aperture in movable roller mounting element 30 so that the stub axle 23 is non-rotatably retained at the adjustment device 24 at inner sidewall 14b of the conveyor.

Optionally, when mounting element 32 is mounted to the inner sidewall 14b, an aperture (such as a hexagonal-shaped aperture or passageway) through mounting element 32 may be generally aligned with an aperture or opening in sidewall 14b so that a stub axle or axle portion 25 of another roller (such as another idler roller 21 adjacent to and upstream from the end roller 22) may be received through the aperture of mounting element 32 to mount the inner end of the roller 21 (such as the middle roller of the three-roller zone in the illustrated embodiment) to the inner sidewall 14b and mounting element 32 when adjustment device 24 is mounted to sidewall 14b of conveyor 10. A set screw or retaining pin or screw or fastener 42 may be inserted into mounting element 32 to substantially secure or retain axle portion 25 in aperture 32c.

Similarly, when adjustment device 24 is mounted to inner sidewall 14b, an aperture (such as a hexagonal-shaped aperture or passageway) through movable roller support element 30 is generally aligned with an aperture or slot 14c (shown in FIG. 8 with the tracking device removed from the sidewall) through inner sidewall 14b. Slot 14c is formed so as to non-rotatably receive the axle portion or stub axle 23, while allowing movement of stub axle 23 along sidewall 14b. Thus, stub axle 23 is received through the aperture of movable roller support element 30 and through slot 14c of inner sidewall 14b to mount or support the end of the roller 22 at the adjustment device 24. A set screw or retaining pin or screw or fastener 44 may be inserted into movable roller support element 30 to substantially secure or retain axle portion 23 in the aperture of movable roller support element 30. Optionally, a retaining element or fastener 48 (FIG. 4) may be secured to the movable roller support element at the end of the axle portion 23 to limit or substantially preclude retraction of the axle portion from the movable roller support element.

In the illustrated embodiment of FIGS. 4, 5, 7 and 9, stub axles 23, 25 are axle portions or stub axles that are inserted through the movable support portion 30 and mounting portion 32, respectively, of adjustment device 24 and through the inner sidewall 14b and partially into the end of the respective roller, such as into a roller bearing element or the like at the end of the respective roller. The stub axles 23, 25 may include a stop tab or lip 23a, 25a at their outer end to limit insertion of the stub axles into and through the tracking device 24. However, other suitable stub axles or axle portions or axles/shafts may be implemented (such as, for example, a stub axle or elongated axle or shaft that extends from the end of the roller and is inserted through the sidewall and at least partially through the aperture in the respective one of the mounting element 32 and movable support element 30), without affecting the scope of the present invention.

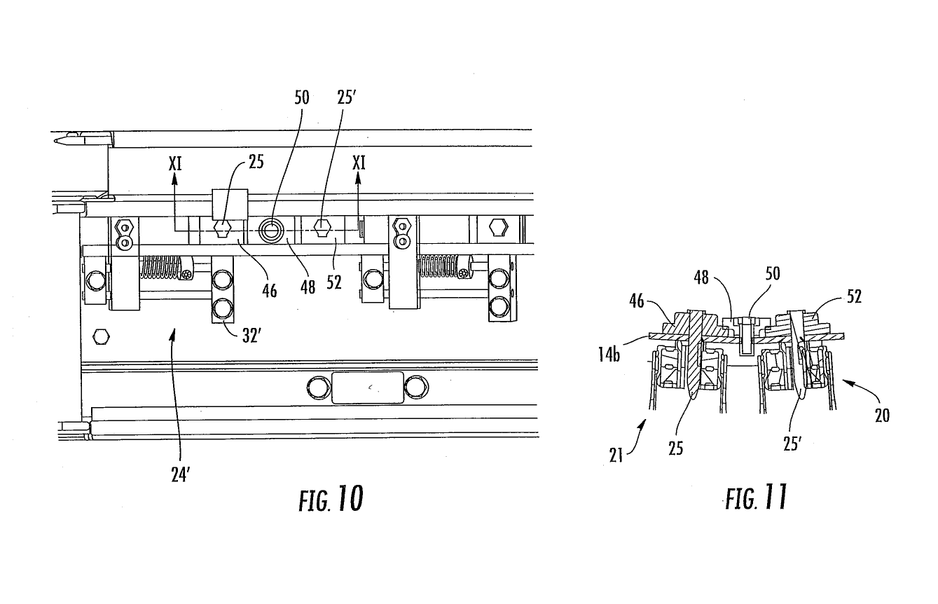

Optionally, for example, and as shown in FIGS. 10 and 11, a mounting element 32′ of a tracking device or roller adjustment device 24′ may not extend upward to overlap and align with the hexagonal-shaped aperture (or other suitable shape for non-rotatably receiving an axle or shaft of a roller) of the inner sidewall 14b. Thus, the stub axle 25 of the idler roller 21 may be inserted through a shaft mounting element 46, which may be clamped or secured at the sidewall 14b via a clamping element 48. Adjustment device 24′ may otherwise be substantially similar to adjustment device 24 such that a detailed discussion of the tracking devices need not be repeated herein. As can be seen with reference to FIGS. 10 and 11, the clamping element 48 may be secured to sidewall 14b via a fastener 50, whereby tightening of fastener 50 draws clamping element 48 toward sidewall 14b to clamp shaft mounting element 46 at sidewall 14b to substantially secure the stub axle 25 at the sidewall 14b. As shown in FIGS. 10 and 11, clamping element 48 may also clamp a second shaft mounting element 52 at sidewall 14b, thereby securing the axle portion 25′ of the downstream roller (such as the driven roller 20 or such as another idler roller of the conveyor or conveyor zone) at the inner sidewall 14b of the conveyor or conveyor zone. Optionally, a set screw or other suitable pin or fastener or the like (not shown) may be inserted at least partially through the shaft mounting elements 46, 52 to secure or substantially secure the stub axles within the respective shaft mounting elements. Optionally, the clamping element and shaft mounting elements may be configured so that the shaft mounting elements are adjusted as the clamping element is tightened against the shaft mounting elements and the sidewall (such as via tightening of fastener 50) to clamp or bind against the stub axles to retain the stub axles within the shaft mounting elements, such as by utilizing aspects of the shaft mounting devices described in U.S. Pat. No. 7,243,784, which is hereby incorporated herein by reference in its entirety.

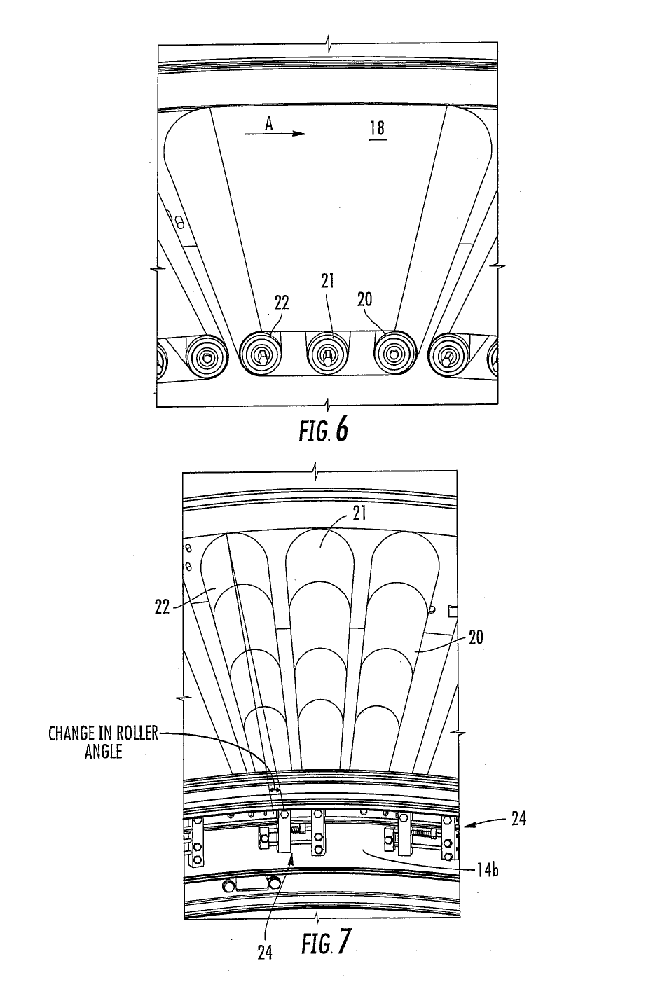

As can be seen with reference to FIG. 7, the roller adjustment device or tracking device 24 functions to adjust the location of the inner end of the end roller at the inner sidewall 14b and thus adjusts an angle of the end roller to track the belt around the rollers of the conveyor or zone. Thus, as the belt may begin to move inward toward the inside of the curve, the tension in the belt may be reduced, whereby the biasing element 38 will urge the end of the roller toward the end of the conveyor or zone (by urging movable roller support element 30 along rods 34a, 34b and thus urging the axle portion or stub axle 23 along slot 14c of inner sidewall 14b) to cause the belt to move outward back to the appropriate location along the rollers. The spring force or biasing force of the biasing element is selected to provide the desired tension and to move the movable roller mounting element when the tension in the belt is reduced below a threshold or desired or appropriate level that corresponds to the belt moving a threshold amount inward along the rollers.

Roller adjustment device 24 thus may adjust the tension in the belt 18 of the respective zone 12 to properly track belt 18 around the rollers of the zone. Roller adjustment device 24 may function to increase/decrease the tension in the belt and change the angle of the upstream roller by moving the inner end of the upstream roller along the sidewall so as to cause the belt to move or track toward/away from the outer sidewall of the conveyor or conveyor zone. Thus, the roller adjustment device or tracking device may function to draw or track the belt radially outward along the curve and toward the outer ends 16a of the rollers in response to driving of the driven roller in a forward direction (which drives the belt to convey articles in the direction of conveyance A) until the belt is properly positioned around the rollers. When properly positioned, the belt may be substantially taught or tight around the inner ends 16b of the rollers to limit further outward movement of the belt along the rollers during operation of the motorized roller in the forward direction. If the belt moves outward beyond an appropriate position along the rollers, the tension in the belt may overcome the spring force of the biasing element and urge the inner end of the upstream roller in the opposite direction along the inner sidewall so that the belt moves toward the inner sidewall until the belt is again tracking around the rollers at the desired or appropriate location along the rollers. The tracking device or roller adjustment device of the present invention thus may continually or substantially continually adjust the location of the inner end of the upstream roller (and thus the angle of the roller) to maintain or track the continuous conveying belt around the rollers of the conveyor or conveyor zone.

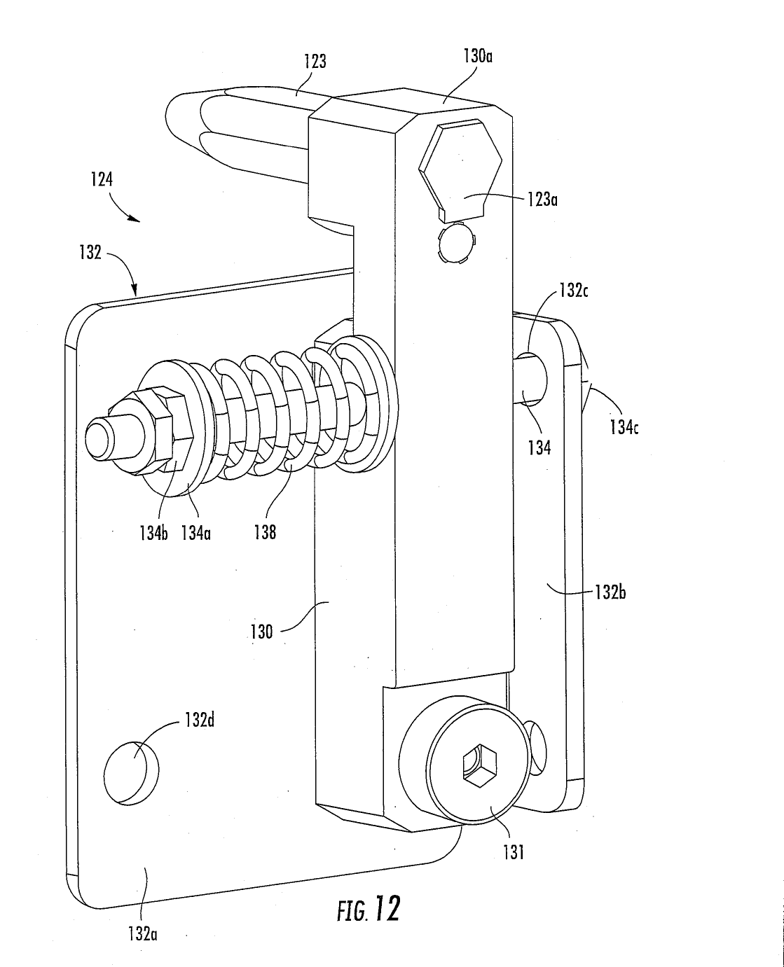

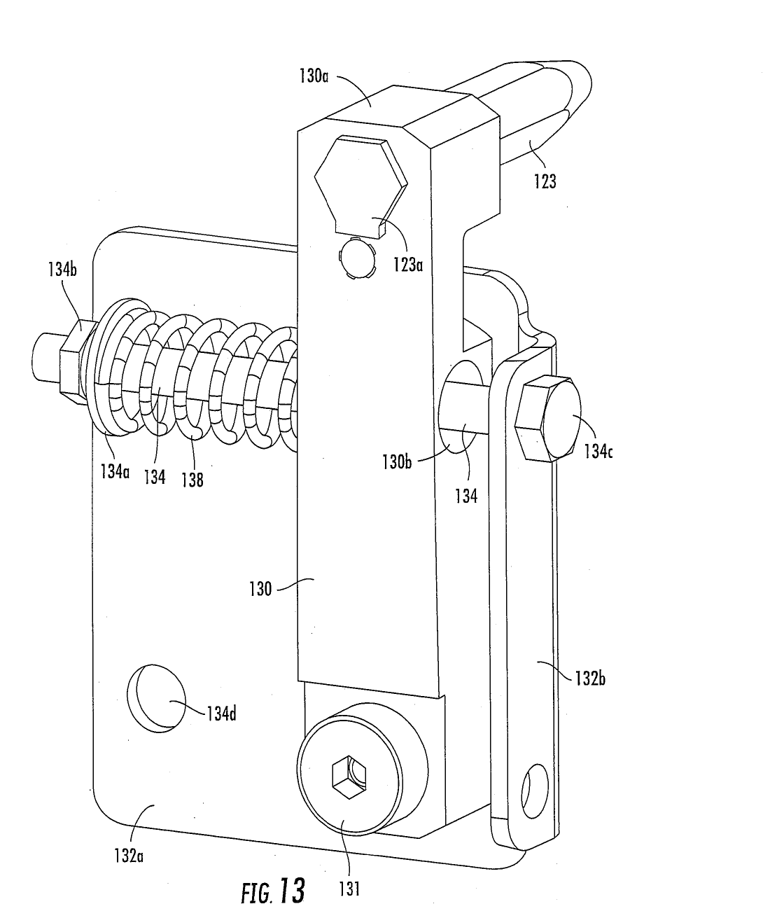

Optionally, and with reference to FIGS. 12-15, a tracking device or roller adjustment device 124 includes a movable roller support element 130 that is pivotally mounted to a mounting element or plate 132 and is pivotable about a pivot pin 131 (such as a bushing or stepped bolt or fastener or the like that may be inserted through a passageway in the movable roller support element and attached to the mounting plate or bracket). In the illustrated embodiment of FIG. 12, mounting plate 132 includes a flat or planar portion 132a, to which movable support element 130 is pivotally mounted, and an outwardly turned mounting flange or portion 132b that extends from planar portion 132a. The mounting flange or portion may include an aperture 132c for mounting a guide rod or post 134 (or may include multiple apertures for mounting multiple guide rods or posts), as discussed below. The planar portion 132a may have one or more fastener holes or apertures 132d therethrough to facilitate mounting or attaching the mounting plate to the sidewall of the conveyor via one or more fasteners or the like.

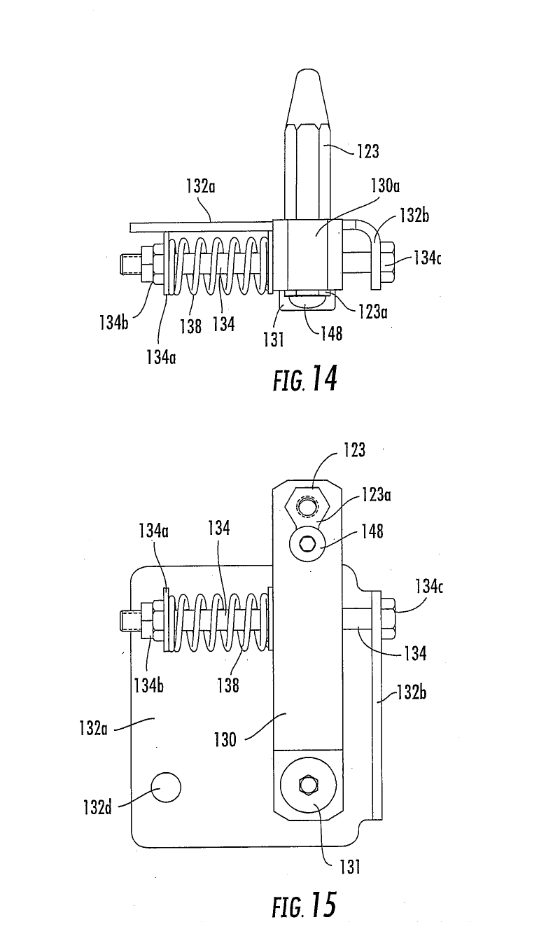

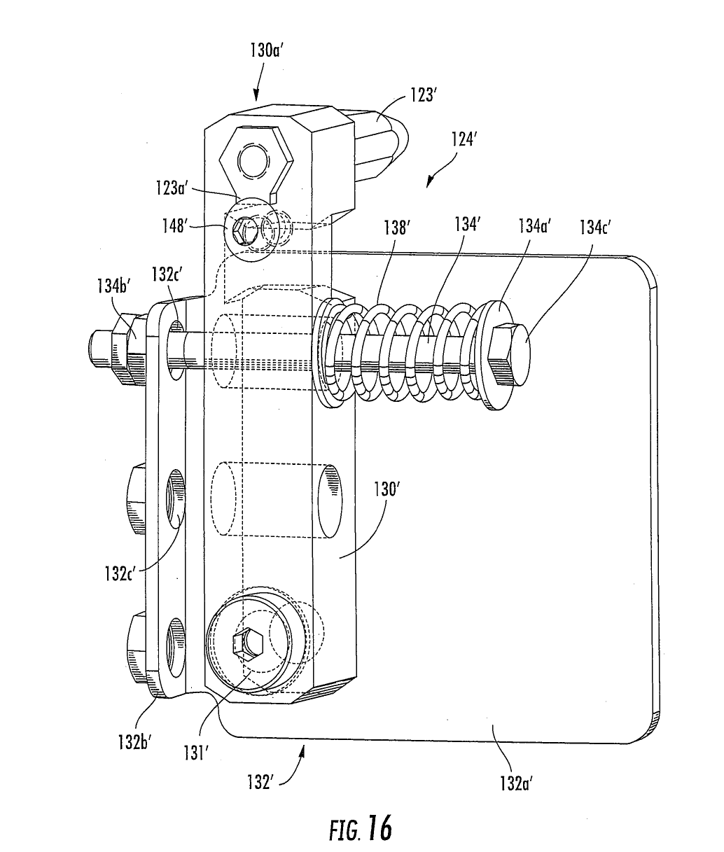

Movable roller support element 130 is pivotally mounted to planar portion 132a via pivot pin 131, and extends upwardly from the pivot pin and includes a shaft receiving portion, 130a at an end opposite from pivot pin 131. Shaft receiving portion 130a includes a passageway therethrough (such as a hexagonal-shaped passageway or other suitable passageway or aperture) for non-rotatably receiving a stub axle or shaft portion 123 of the roller therein or therethrough. In the illustrated embodiment, a retaining fastener or pin or element 148 (FIGS. 14 and 15) may be attached to shaft receiving portion 130a and may overlap an outer end of the stub axle 123 (such as at a tab or lip 123a of the stub axle) to secure stub axle 123 at shaft receiving portion 130a of movable roller support element 130.

Roller adjustment device 124 includes a guide rod or post 134 (or could include two rods or posts if desired) that extends from mounting flange 132b (such as through passageway 132c) and extends through a passageway 130b of movable roller support element 130. A spring or biasing element 138 is positioned along rod 134 and functions to bias or urge movable roller support element 130 toward the upstream end of the conveyor or conveyor zone (such as in the opposite direction of the direction of conveyance of the zone or conveyor). In the illustrated embodiment, the biasing element 138 is positioned along rod 134 and between a stop element or washer 134a at an end of the rod 134 (such as at a threaded end of the rod with a female fastener or nut 134b (and such as two female fasteners as shown in FIGS. 12-15 to limit rotation or movement of the fasteners relative to the threaded end of the rod when the fasteners are tightened together) or other stop means or element) and the movable roller support element 130, such that the biasing element urges the shaft receiving portion 130a of the movable roller support element 130 toward the mounting portion 132b of mounting element 132. The opposite end of the rod 134 may be generally fixed relative to the mounting flange 132b via a head 134c of the rod or bolt or fastener 134 engaging the mounting flange 132b at and around the passageway 132c.

Thus, mounting element 132 of roller adjustment device 124 is mounted to the inner sidewall of the conveyor or conveyor zone so that the planar portion 132a is generally at or against the inner sidewall and the mounting flange 132b is at the upstream end of the roller adjustment device. The shaft receiving portion 130a of movable roller support element 130 is positioned or oriented so that the aperture or passageway is generally aligned with an aperture or slot along the inner sidewall (such as a slot similar to slot 14c of inner sidewall 14b discussed above). Biasing element 138 thus biases or urges pivotal movement of movable roller support element 130 toward the mounting flange 132b of mounting element 132 and thus toward the upstream end of the conveyor or conveyor zone, and thus roller adjustment device 124 functions in a similar manner as described above with respect to roller adjustment device 24. Mounting portion 132 may be mounted to the inner sidewall of the conveyor via fasteners through planar portion 132a or may be mounted to a mounting element at the inner sidewall via fasteners through mounting flange 132b, or may be otherwise mounted to or at the inner sidewall, without affecting the scope of the present invention. Although shown as being pivotally mounted to the mounting element 132, it is envisioned that the movable support element of the tracking device may be slidably mounted to a pair of rods or posts extending from the mounting flange of the mounting element so as to be substantially translationally movable along the posts in response to the biasing element and/or tension in the conveying belt, while remaining within the spirit and scope of the present invention.

In the illustrated embodiment of FIGS. 12-15, the roller adjustment device 124 is configured to bias the end of the roller in a selected direction (such as, for example, and such as shown in FIG. 15, toward the right for a conveyor or zone having a direction of conveyance toward the left). Optionally, and with reference to FIG. 16, a roller adjustment device 124′ may be configured to bias the end of the roller in a direction opposite the direction of bias for roller adjustment device 124. Thus, a selected or appropriate roller adjustment device may be provided and mounted at the sidewall of the conveyor or zone to bias the end of the roller in the desired or appropriate direction depending on the direction of conveyance of the conveyor or zone. The mounting bracket or plate 132′ of roller adjustment device 124′ may be the same as the mounting bracket or plate 132 of roller adjustment device 124, discussed above, but the mounting plate may be inverted or flipped over, with the pivot pin 131′ mounting the movable support element 130′ at a different aperture of the planar portion 132a′ of mounting plate 132′, and with the guide rod 134′ extending through a different aperture of the mounting flange 132b′, thereby providing common components for the different applications of the roller adjustment device. The other components may be similar or the same for the roller adjustment devices to enhance the manufacturing and assembly of the devices.

Optionally, and as shown in FIG. 16, the mounting flange or portion 132b′ includes two apertures 132c′ to accommodate mounting two guide rods or posts 134′ to provide the desired or appropriate biasing force at the movable support element 130′. The movable roller support element 130′ includes shaft receiving portion 130a′ having a passageway therethrough (such as a hexagonal-shaped passageway or other suitable passageway or aperture) for non-rotatably receiving a stub axle or shaft portion 123′ of the roller therein or therethrough, such as described above. A retaining fastener or pin or element 148′ may be attached to shaft receiving portion 130a′ and may overlap an outer end of the stub axle 123′ (such as at a tab or lip 123a′ of the stub axle) to secure stub axle 123′ at shaft receiving portion 130a′ of movable roller support element 130′.

In a similar manner as described above, a spring or biasing element 138′ is positioned along rod 134′ and functions to bias or urge movable roller support element 130′ toward the upstream end of the conveyor or conveyor zone. In the illustrated embodiment of FIG. 16, the biasing element 138′ is positioned along rod 134′ and between a stop element or washer 134a′ at an end of the rod 134′ (such as at a head 134c′ of the rod 134′) and the movable roller support element 130′, such that the biasing element urges the shaft receiving portion 130a′ of the movable roller support element 130′ toward the mounting portion 132b′ of mounting element 132′. The opposite end of the rod 134′ may be generally fixed relative to the mounting flange 132b′ via a female fastener or nut 134b at a threaded end of the rod (or via any other suitable stop means or element) engaging the mounting flange 132b′ at and around the passageway 132c′. Roller adjustment device 124′ may otherwise be substantially similar to and function in a similar manner as roller adjustment device 124, discussed above, such that a detailed discussion of the roller adjustment devices need not be repeated herein.

Although shown and described as adjusting or moving the inner end of the upstream roller along the inner sidewall of the conveyor to track the conveying belt around the rollers, it is envisioned that a tracking or roller adjustment device or devices of the present invention may be located at the outer end of the upstream roller while remaining within the spirit and scope of the present invention. The outer end of the upstream roller may then be moved or adjusted to adjust the angle in the roller and/or tension in the belt, and the roller adjustment device may bias or urge or move the end of the roller in the appropriate direction along the outer sidewall of the conveyor or conveyor zone. Optionally, it is envisioned that a tracking device or roller adjustment device in accordance with the present invention may be located at the inner end or outer end of the downstream or rotatably driven roller to adjust the end of the driven roller in a similar manner as described above with respect to the upstream idler roller to track the belt around the rollers of the conveyor or conveyor zone, while remaining within the spirit and scope of the present invention.

Although shown and described as having a biasing element or spring that urges the end of the roller in the appropriate direction, it is envisioned that the end or ends of the roller or roller may be otherwise moved or adjusted in the appropriate direction to track the belt. For example, an electro-mechanical device or motorized device may automatically move or adjust the end of the roller, such as in response to a detection of one or more threshold tension levels in the conveyor belt, such as may be detected by a sensor or sensors at the belt. The device may continuously or substantially continuously adjust the end or ends of one of the rollers (such as the upstream roller) to maintain the tension in the belt at or near a desired or appropriate or targeted level to track the belt around the rollers.

Optionally, and desirably, each curved zone of the curved belt conveyor may provide approximately a 15 degree angle or curve. This angle may be selected because multiples of this angle may provide standard or desired curves, such as 15, 30, 45, 60 and/or 90 degree curves (or other curves, such as greater curves or lesser curves, depending on the particular application of the belt conveyor), which are often desired or required in conveyor layouts. Optionally, each curved zone may provide any other curve or angle, such as a 10 degree curve, a 22.5 degree curve, a 30 degree curve or the like, without affecting the scope of the present invention. By limiting the size of the angle of the curved zone, the continuous conveying belt may also be limited to a relatively small size, which helps to maintain the belt in its proper position around the rollers, and may reduce the load on the driven roller, such as a motorized or powered roller having an internal motor. Although shown and described as being implemented on short curved zones or sections, it is envisioned that the roller adjustment device may be implemented at other curved conveyors or conveyor sections and/or at straight or substantially straight conveyors or conveyor sections, while remaining within the spirit and scope of the present invention.

Each curved zone or segment (such as curved zones 12 of FIGS. 1 and 2) may also include a photo-eye or article sensor or photosensor (such as photo-eyes 26 shown in FIG. 2) for detecting and/or monitoring articles or packages or the like on the belt 18 of the respective zone. The curved belt conveyor 10 may further include a control 27 (FIG. 2) for independently operating the motorized roller 20 of the respective zone to move the articles along the zone or segment 12 and/or to temporarily stop the movement of an article or articles, in order to accumulate articles on the zone or segment 12, in response to the photo-eye or sensor 26 and depending on the particular application of the curved belt conveyor 10. The control and photo-eyes may be operable to accumulate articles on the curved belt conveyor, and may be operable to individually or independently control operation of at least some of the zones, such as by utilizing the principles disclosed in U.S. Pat. Nos. 7,063,206; 6,811,018 and 7,093,709, and U.S. patent application Ser. No. 11/504,509, filed Aug. 15, 2006 by Cotter et al. for BELT CONVEYOR (Attorney Docket DEM04 P-100C.), which are hereby incorporated herein by reference in their entireties.

Optionally, the curved belt conveyor of the present invention may provide an increased coefficient of friction between the belted conveying surface and the products being conveyed therealong over the friction provided by rollers of conventional roller conveyors. The curved belt conveyor of the present invention thus may be operable at a greater speed than conventional roller conveyors, without causing the products to slide radially outwardly around the curved zone or segment. The curved belt conveyor of the present invention may also provide enhanced capability to move and accumulate articles along each zone individually.

The curved belt conveyor of the present invention thus may be operable to accumulate articles on one or more of the curved segments or zones of the conveyor. Optionally, the curved belt conveyor may be operable on an incline or decline and may accumulate articles on the incline or decline. It is further envisioned that the curved belt conveyor may be operable to move articles, such as upward along an incline, as the articles are required by a downstream device or system. It is envisioned that the curved sections or zones of the conveyor may combine to form a generally spiral-shaped incline or decline.

Therefore, the curved belt conveyor of the present invention is operable to track or maintain the belt in its proper or desired or appropriate position on the rollers as the belt is driven around the rollers via the driven roller or motorized roller. The tracking device or roller adjustment device of the present invention is located at the sidewall of the conveyor and moves or adjusts the position of the roller axle or axle portion to maintain the appropriate tension in the belt and thus to track the belt along the conveyor, such that no additional tracking devices or components are necessary along the outer or inner edges of the belt to maintain the belt in position around the rollers.

Optionally, one or more of the rollers may include a crown or other form of raised portion of the roller surface, such that the crown protrudes outwardly from the generally cylindrical or conical roller surface of the roller toward and into engagement with the interior surface of the conveyor belt, such as by utilizing aspects of the curved belt conveyors of the types described in U.S. Pat. Nos. 6,971,510 and 7,150,352, which are hereby incorporated herein by reference in their entireties. The crown or tracking means may assist in tracking or maintaining the conveyor belt at the desired and appropriate position about rollers. Optionally, and desirably, the crown or tracking means may provide a small crown or bump or ridge so that the crown or bump or ridge on the roller surface does not form a bump or ridge on the belt and at the outer surface of the conveyor belt. Optionally, it is envisioned that the crown or tracking means may be a barrel crown extending substantially along the length of the roller, without affecting the scope of the present invention. Optionally, the tracking means may include several crowns or raised portions spaced along a tapered or cylindrical roller. Optionally, it is envisioned that a roller, such as a tapered roller, may comprise multiple separate sleeves or sections, which may be assembled to form the roller. Optionally, one or more of the sleeves or sections may comprise a crowned sleeve or section, while the other sleeves or sections may comprise straight or uncrowned sleeves or sections, such as described in U.S. Pat. Nos. 6,971,510 and 7,150,352, which are hereby incorporated herein by reference in their entireties.

Optionally, the curved belt conveyor of the present invention may include a tracking means or tracking member positioned on and/or around at least one of the rollers and/or at the interface between the roller surface and the belt which functions to maintain the belt in the desired and appropriate position around the rollers. For example, one or more of the rollers of the conveyor may have a roller surface characteristic, while the interior surface of the belt may have a belt surface characteristic. The surface characteristics at the interface of the roller and the belt may function to track and guide the belt at the desired or appropriate orientation or location on the roller. The surface characteristics may comprise corresponding ridges, grooves or crowns in or on the respective surfaces of the belt and/or roller, which generally resist lateral movement of the belt along the roller surface. The surface characteristic or tracking means may be a separate component, such as a band or the like, around the roller and between the roller surface and the interior surface of the belt, without affecting the scope of the present invention. Optionally, the belt may have a stretch quality or characteristic which also functions to track or assist in tracking the belt on the rollers.

The curved belt conveyor of the present invention may provide a plurality of independently operable curved zones or segments which may operate together as a generally continuously running curved belt conveyor or may operate individually as an accumulating conveyor with zone control and photo eyes or article sensors. The present invention thus provides a zone controlled curved belt conveyor which may operate in a similar manner as a zone controlled roller conveyor, but which includes a belt around the rollers rather than multiple O-rings or the like connecting the idler rollers to the motorized roller of each zone. The curved belt conveyor of the present invention thus may be capable of accumulating articles on an incline or decline. The belt conveying surface may also facilitate operation of the conveyor at greater speeds over the speed of conventional curved roller conveyors. Also, because the motorized roller of each zone or segment may only control or drive a small belt section, such as a belt around approximately two, three or four rollers, the load and wear on the motorized roller may be minimized to provide a longer life cycle for the motorized roller.

Therefore, the present invention provides a means or device for tracking a belt around at least two rollers of a curved segment or section or zone of a conveyor. The rollers of each zone may include a rotatably driven roller operable to drive the belt around the rollers. The tracking device or roller adjustment device of the present invention may maintain or track the belt in its proper position or orientation around the rollers, such that the tracking guide elements and wider conveyor portions of conventional curved belt conveyors are not required in connection with the curved belt conveyor of the present invention. Because the separate tracking or guide elements or devices that engage the belt are not required to maintain the belt in place on the rollers, the curved belt conveyor of the present invention may be designed within the confines of standard width conveyors and conveyor sidewalls.

Changes and modifications in the specifically described embodiments may be carried out without departing from the principles of the present invention, which is intended to be limited only by the scope of the appended claims, as interpreted according to the principles of patent law.

The embodiments of the invention in which an exclusive property right or privilege is claimed are defined as follows:

1. A belt conveyor comprising:
opposite sidewalls;
at least two rollers positioned along and between said opposite sidewalls of said conveyor, said rollers comprising an adjustable roller and an end roller;
a continuous belt reeved around said at least two rollers; and
an automatic tracking device mounted at one of said sidewalls and adjustably supporting an end of said adjustable roller, said tracking device adjusting an angle of said adjustable roller relative to said sidewalls to track said belt with said rollers.

2. The belt conveyor of claim 1, wherein said one of said sidewalls receives an axle portion of said adjustable roller in a slotted aperture, said automatic tracking device adjusting a position of said axle portion of said adjustable roller along said slotted aperture to track said belt with said rollers.

3. The belt conveyor of claim 1, wherein said belt conveyor comprises a curved belt conveyor having a curved inner sidewall and a curved outer sidewall, and wherein said at least two rollers comprise tapered conveying rollers.

4. The belt conveyor of claim 3, wherein said automatic tracking device is mounted at said inner sidewall of said curved belt conveyor.

5. The belt conveyor of claim 4, wherein said automatic tracking device urges said end of said adjustable roller generally away from said end roller in response to a reduction in belt tension as said belt moves toward said inner sidewall, and wherein said end of said adjustable roller is moved generally toward said end roller in response to an increase in belt tension as said belt moves toward said outer sidewall.

6. The belt conveyor of claim 1, wherein said automatic tracking device adjusts said angle of said adjustable roller in response to a change in tension of said belt.

7. The belt conveyor of claim 1, wherein said automatic tracking device comprises a fixed mounting element that is substantially fixedly mounted to said one of said sidewalls and a movable mounting element that adjustably supports said end of said adjustable roller, said movable mounting element being adjustably connected to said fixed mounting element, and wherein said automatic tracking device further comprises a biasing element that functions to bias said movable mounting element in a direction generally transverse to a longitudinal axis of said adjustable roller and relative to said fixed mounting element.

8. The belt conveyor of claim 7, wherein said movable mounting element is slidably movable relative to said fixed mounting element.

9. The belt conveyor of claim 7, wherein said movable mounting element is pivotally movable relative to said fixed mounting element.

10. The belt conveyor of claim 7, wherein said movable mounting element adjustably supports said end of said adjustable roller via a stub axle that extends at least partially through said movable mounting element and into a bearing element at said end of said adjustable roller.

11. The belt conveyor of claim 1, wherein said end roller comprises a driven roller rotatably drivable to drive said belt around said rollers.

12. The belt conveyor of claim 1 including a control which is operable to independently control operation of a driven one of said rollers to provide accumulation of articles on said curved belt conveyor, wherein said control is operable to independently control operation of said driven roller in response to at least one article sensor.

13. A curved belt conveyor comprising:
at least two tandem zones, each of said zones having a first roller at one end of said zone and a second roller at an opposite end of said zone, said rollers being positioned along and between curved opposite sidewalls of said conveyor, each of said rollers having an axle portion and a roller portion rotatable relative to said axle portion;
a continuous belt reeved around at least two of said rollers;
an automatic tracking device mounted at one of said curved sidewalls and adjustably supporting an end of said first roller, said tracking device adjusting an angle of said first roller relative to said sidewalls to adjust the tension in said belt at said rollers to track said belt with said rollers; and
a control operable to independently control operation of said at least two zones to provide accumulation of articles on said curved belt conveyor, wherein said control is operable to independently control operation of said at least two zones in response to at least one article sensor.

14. The curved belt conveyor of claim 13, wherein said automatic tracking device urges said end of said axle portion of said first roller generally away from said second roller in response to a reduction in belt tension as said belt moves toward an inner one of said sidewalls, and wherein said axle portion of said first roller is moved generally toward said second roller in response to an increase in belt tension as said belt moves toward an outer one of said sidewalls.

15. The curved belt conveyor of claim 13, wherein said automatic tracking device comprises a fixed mounting element that is substantially fixedly mounted to said one of said sidewalls and a movable mounting element that adjustably supports said end of said first roller, said movable mounting element being adjustably connected to said fixed mounting element, and wherein said automatic tracking device further comprises a biasing element that functions to bias said movable mounting element in a direction generally transverse to a longitudinal axis of said adjustable roller and relative to said fixed mounting element.

16. The curved belt conveyor of claim 15, wherein said movable mounting element is slidably movable relative to said fixed mounting element.

17. The curved belt conveyor of claim 15, wherein said movable mounting element is pivotally movable relative to said fixed mounting element.

18. The curved belt conveyor of claim 15, wherein said movable mounting element adjustably supports said end of said first roller via a stub axle that extends at least partially through said movable mounting element and into a bearing element at said end of said first roller.

19. The curved belt conveyor of claim 13, wherein said second roller comprises a driven roller rotatably drivable to drive said belt around said rollers.

20. A method of conveying articles, said method comprising:
providing a belt conveyor comprising opposite sidewalls, at least two rollers positioned along and between said opposite sidewalls and a continuous belt reeved around said at least two rollers, said rollers comprising an adjustable roller and an end roller; and
automatically adjusting an end of said adjustable roller to adjust an angle of said adjustable roller relative to said sidewalls to track said belt with said rollers.

21. The method of claim 20, wherein providing a belt conveyor comprises providing a curved belt conveyor comprising curved opposite sidewalls, and wherein said adjustable roller and said end rollers comprise tapered rollers.

22. The method of claim 21, wherein automatically adjusting an end of said adjustable roller comprises automatically adjusting an inner end of said adjustable roller that is at an inner curved sidewall of said curved belt conveyor.

23. The method of claim 20, wherein automatically adjusting an end of said adjustable roller comprises automatically adjusting an end of said adjustable roller in response to a change in tension of said belt.

24. The method of claim 20 further comprising providing an automatic tracking device having a fixed mounting element that is substantially fixedly mounted to one of said sidewalls and a movable mounting element that adjustably supports said end of said adjustable roller, and wherein automatically adjusting an end of said adjustable roller comprises automatically adjusting an end of said adjustable roller via moving said movable mounting element relative to said fixed mounting element.

25. The method of claim 24, wherein automatically adjusting an end of said adjustable roller comprises automatically adjusting an end of said adjustable roller via a biasing element that functions to bias said movable mounting element in a direction generally transverse to a longitudinal axis of said adjustable roller and relative to said fixed mounting element.
